(19) United States
(12) Patent Application Publication
(10) Pub. No.: US 2015/0301358 A1
(43) Pub. Date: Oct. 22, 2015

(54) EYEGLASS LENS STRUCTURE

(71) Applicant: PROHERO GROUP CO., LTD., Tainan City (TW)

(72) Inventor: PEN-WEI CHEN, TAINAN CITY (TW)

(73) Assignee: PROHERO GROUP CO., LTD., Tainan City (TW)

(21) Appl. No.: 14/256,161

(22) Filed: Apr. 18, 2014

(51) Int. Cl. G02C 7/12; G02B 1/04; G02B 1/18; G02C 7/02

(52) U.S. Cl. CPC G02C 7/12; G02C 7/02; G02B 1/041; G02B 1/18

(57) ABSTRACT

An eyeglass lens structure is disclosed herein to a substrate, a polarizing layer, a photochromic layer, a reinforcing layer, an isolation layer all on a top surface of the substrate of a lens, and an antifogging layer on a bottom surface of the substrate, for effectively reducing eye hurts by glare, protecting eyes from glare, preventing the lens against scratches. from sticking dirt and water, and from fogging.

### BACKGROUND OF THE INVENTION

1. Fields of the Invention

The present invention relates to an eyeglass lens structure, especially to a lens which can effectively reduce eye hurts by glare, protect eyes from glare, prevent the lens against scratches, from sticking dirt and water, and be anti-fogging for undesired influence on vision.

2. Descriptions of Related Art

Generally, eyeglasses include glasses for nearsightedness, reading glasses for presbyopia, sunglasses, and protective goggles depending on various purposes of use. No matter what kind of glasses to be used in any specific fields, lenses thereof are disposed in frames thereof and temples thereof are pivoted on the both sides of the frames thereof by screwing components for an full assembly of glasses.

Among these, in terms of common lenses, various lenses in the early are only for simple vision correction and eye protection. As technology advances and processing technology flourishes, so that all kinds of additional features for the lenses start to be developed. The efficiency is achieved by the various types of materials attached on the surface of the lenses. such as an anti-fog layer used to prevent fogging of the lens surface, and a photochromic layer used to change the color of the lens with the light intensity for protecting eyes from hurts.

Although the above structure of attaching various materials on the lens surface can achieve various pre-established effectiveness, the lens only has one additional function in the practical implementation. Therefore, a user needs to wear various glasses having lenses with different functions at different occasions. It causes not only great inconvenience in usage, but also significant economic burden for preparation of plural pairs of eyeglasses, causing much more inconvenience in carrying.

### SUMMARY OF THE INVENTION

Therefore, an eyeglass lens structure is developed herein to improve the above shortcomings, in order to achieve valuable purposes in practical usage.

In order to achieve the above objectives, an eyeglass lens structure in the present invention is designed to include a substrate, a polarizing layer, a photochromic layer, a reinforcing layer, an isolation layer all on a top surface of the substrate of a lens, and an antifogging layer on a bottom surface of the substrate. In such a case, the lens can simultaneously have a polarizing effect to effectively reduce eye hurts caused by glare, change the lens color with the light intensity to protect eyes from shining, be anti-scratched, anti-fogged and be free from attachment of dirt and water thereon to further avoid undesired influence on users' vision.

The main purpose and effect of the eyeglass lens structure in the present invention are achieved by following specific techniques.

The lens has a substrate, a polarizing layer on a top surface of the substrate, a photochromic layer on a top surface of the polarizing layer, a reinforcing layer on a top surface of the photochromic layer, an isolation layer on a top surface of the reinforcing layer, and an antifogging layer on the bottom surface of the substrate.

In the present invention, the isolation layer is an antifouling layer.

In the present invention, the isolation layer is a water repellent layer.

In the present invention, a multilayer film is disposed between the reinforcing layer and the isolation layer.

### BRIEF DESCRIPTION OF THE DRAWINGS

The structure and the technical means adopted by the present invention to achieve the above and other objects can be best understood by refereeing to the following detailed description of the preferred embodiments and the accompanying drawings, wherein

FIG. 1 is a decomposed schematic diagram showing the first embodiment of an eyeglass lens structure according to the present invention;

FIG. 2 is a decomposed schematic diagram showing the second embodiment of an eyeglass lens structure according to the present invention.

### DETAILED DESCRIPTION OF THE PREFERRED EMBODIMENT

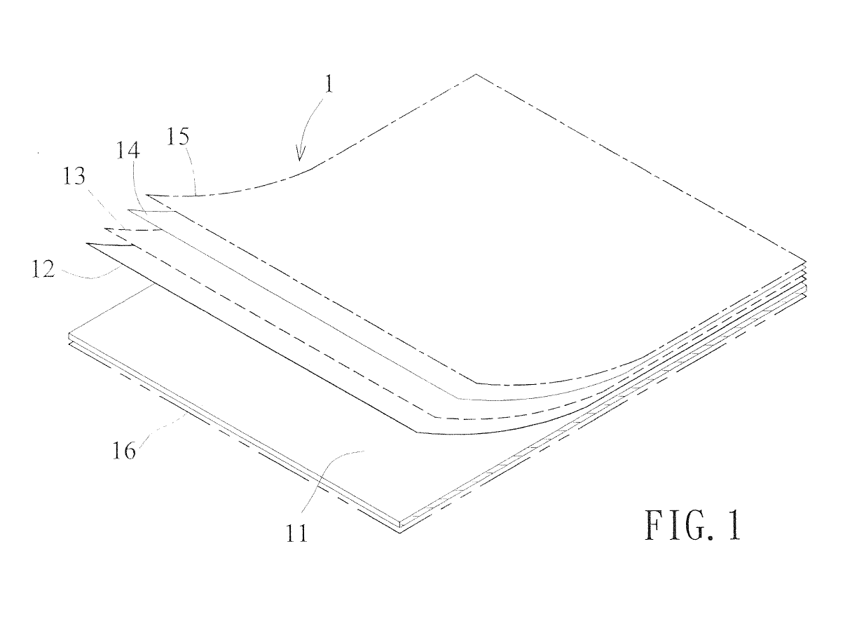

Firstly, as referring to FIG. 1. it shows that a decomposed schematic diagram showing the first embodiment of an eyeglass lens structure according to the present invention. The lens (1) has a substrate (11). a polarizing layer (12) on a top surface of the substrate (11). a photochromic layer (13) on a top surface of the polarizing layer (12), wherein the polarizing layer (12) and the photochromic layer (13) are formed by the combination with the substrate (11) through the processing, a reinforcing layer (14) on a top surface of the photochromic layer (13), an isolation layer (15) on a top surface of the reinforcing layer (14), and an antifogging layer (16) on a bottom surface of the substrate (11). in which the isolation layer (15) is an antifouling layer or a water repellent layer.

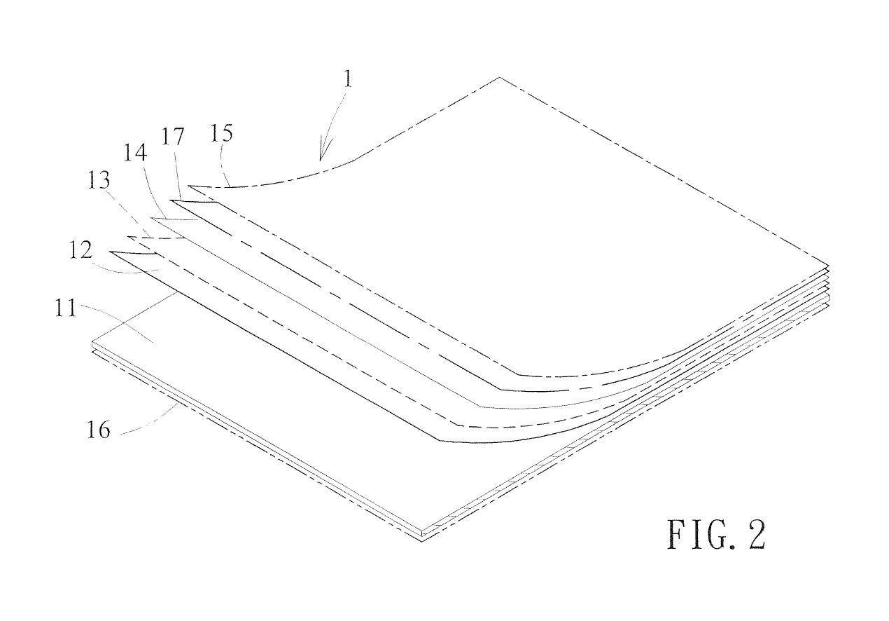

As further referring to FIG. 2, it shows that a decomposed schematic diagram showing the second embodiment of an eyeglass lens structure according to the present invention. A multilayer film (17) can be disposed between the reinforcing layer (14) and the isolation layer (15) of the lens (1) in the present invention.

Thus, the finished lens (1) can be combined with an eyeglass frame after being ground to be a predetermined shape. In wearing thereof by users, the polarizing layer (12) on the substrate (11) of the lens (1) enables to show a polarizing effect to effectively reduce eye hurts by glare. The photochromic layer (13) can be used to change the color of the lens (1) with different light intensity to protect eyes from shining. The reinforcing layer (14) has a reinforcing effect to protect the lens (1) from scratching. The isolation layer (15), also as an antifouling layer or a water repellent layer, has a barrier effect to protect the lens (1) from sticking dirt or water dips, and the antifogging layer (16) on the bottom surface of the substrate (11) can be used to protect the lens (1) from fogging so as to further avoid undesired influence on viewing. Additionally, the multilayer film (17) between the reinforcing layer (14) and the isolation layer (15) allows the lens (1) to be anti-reflective to reduce a reflectivity of surfaces of the lens (1) and to enhance a perspective rate on the lens (1).

In conclusion, comparing with techniques available now, the present invention disposes the polarizing layer, the photochromic layer, the reinforcing layer, the isolation layer on the top surface of the substrate of the lens, and the antifogging layer on the bottom surface of the substrate, so that the lens can simultaneously reduce eye hurts by glare, protect eves from glare, prevent the lens against scratches, from sticking dirt and water, and be anti-fogging for undesired influence on vision.

What is claimed is:

1. An eyeglass lens structure, comprising:
a substrate;
a polarizing layer formed on a top surface of the substrate;
a photochromic layer formed on a top surface of the polarized layer;
a reinforcing layer formed on a top surface of the photochromic layer;
an isolation layer formed on a top surface of the reinforcing layer; and
an antifogging layer formed on a bottom surface of the substrate.

2. The eyeglass lens structure as claimed in claim 1, wherein the isolation layer is an antifouling layer.

3. The eyeglass lens structure as claimed in claim 1, wherein the isolation layer is a water repellent layer.

4. The eyeglass lens structure as claimed in claim 1, wherein a multilayer film is disposed between the reinforcing layer and the isolation layer.
